(19) United States
(12) Patent Application Publication
(10) Pub. No.: US 2010/0159436 A1
(43) Pub. Date: Jun. 24, 2010

(54) Repeatedly Written Soft Base Material

(76) Inventor: Chuan-Sheng Huang, Sioushuei Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/388,770

(22) Filed: Feb. 19, 2009

(30) Foreign Application Priority Data
Dec. 19, 2008 (TW) 097222802

(51) Int. Cl. G09F 19/06

(52) U.S. Cl. 434/430

(57) ABSTRACT

A repeatedly written soft base material is a heat-proof aluminum foil paper that can be rolled as a cylinder and comprises a white writing layer preprocessed and coated on the base material in a powder coating manner, and a repeatedly adhesive layer or a double sided tape disposed on another side of the base material. The powder coating method includes adding few fiberglass and CaCO3 into solvent resistance paints to compound powder paints, and then coating the powder paints onto one side of the base material by using static electricity theory, finally baking the base material at 200 degree temperature. Besides, a release paper can be adhered on a surface of the adhesive layer of the base material.

### BACKGROUND OF THE INVENTION

1. Field of the Invention

The present invention relates to a repeatedly written soft base material that can be portable, stored easily, and repeatedly adhered in various objects, such as a wall, a plate member, or a notebook.

2. Description of the Prior Art

As shown in FIG. 1, conventional whiteboard includes a metal plate, a middle layer, and a back panel to be assembles as a board body 10 with a frame 20 disposed on its rim. The whiteboard is hanged to the wall or fixed to a movable holder.

However, such a conventional whiteboard is too heavy to prevent its fall from the wall effectively and to be portable easily.

The present invention has arisen to mitigate and/or obviate the afore-described disadvantages.

### SUMMARY OF THE INVENTION

The primary object of the present invention is to provide a repeatedly written soft base material that can be portable, stored easily, and repeatedly adhered in various objects, such as a wall, a plate member, or a notebook.

A Further object of the present invention is to provide a repeatedly written soft base material that can be cut to a desired size to be adhered onto various sizes of objects.

Another object of the present invention is to provide a repeatedly written soft base material that can be used repeatedly, obtaining environmental friendly purpose.

To obtain the above objective, a repeatedly written soft base material provided by the present invention is a heat-proof aluminum foil paper that can be rolled as a cylinder and comprises a white writing layer preprocessed and coated on the base material in a powder coating manner, and a repeatedly adhesive layer or a double sided tape disposed on another side of the base material. The powder coating method includes adding few fiberglass and CaCO3 into solvent resistance paints to compound powder paints, and then coating the powder paints onto one side of the base material by using static electricity theory, finally baking the base material at 200 degree temperature. Besides, a release paper can be adhered on a surface of the adhesive layer of the base material.

### BRIEF DESCRIPTION OF THE DRAWINGS

FIG. 1 is a perspective view of a conventional whiteboard;

FIG. 2 is an assembly view of a repeatedly written soft base material in accordance with the present invention;

FIG. 3 is a partial cross sectional view of the repeatedly written soft base material in accordance with the present invention;

FIG. 4 is a perspective view showing the operation of the repeatedly written soft base material of the present invention;

FIG. 5 is another perspective view showing the operation of the repeatedly written soft base material of the present invention;

FIG. 6 is another perspective view showing the operation of the repeatedly written soft base material of the present invention;

FIG. 7 is another perspective view showing the operation of the repeatedly written soft base material of the present invention;

FIG. 8 is a partial cross sectional view of the repeatedly written soft base material in accordance with another embodiment of the present invention.

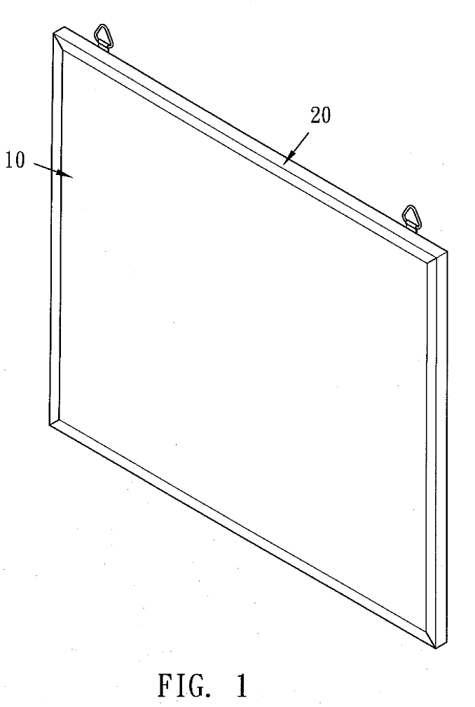

### DETAILED DESCRIPTION OF THE PREFERRED EMBODIMENTS

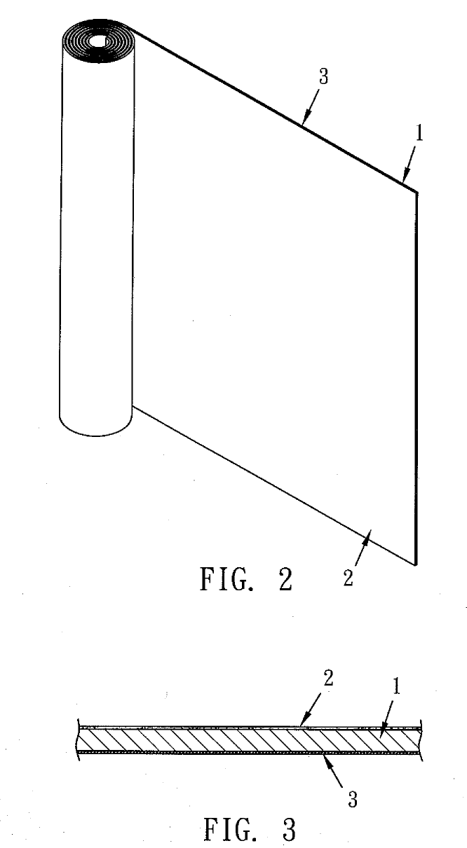

As shown in FIGS. 2 and 3, a repeatedly written soft base material 1 in accordance with the present invention is a heat-proof aluminum foil paper that can be rolled as a cylinder. One side of the base material 1 is preprocessed and coated with a white writing layer 2 (can be coated with other colors as well) in a powder coating manner, and another side thereof is disposed a repeatedly adhesive layer 3 or a double sided tape. The powder coating method includes adding few fiberglass and CaCO3 into solvent resistance paints to compound powder paints, and then coating the powder paints onto one side of the base material 1 by using static electricity theory, finally baking the base material 1 at 200□ temperature. Besides, a release paper can be adhered on a surface of the adhesive layer 3 of the base material 1.

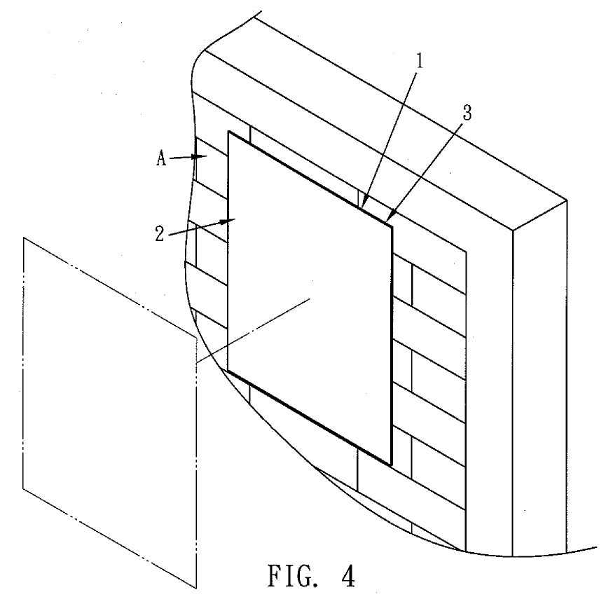

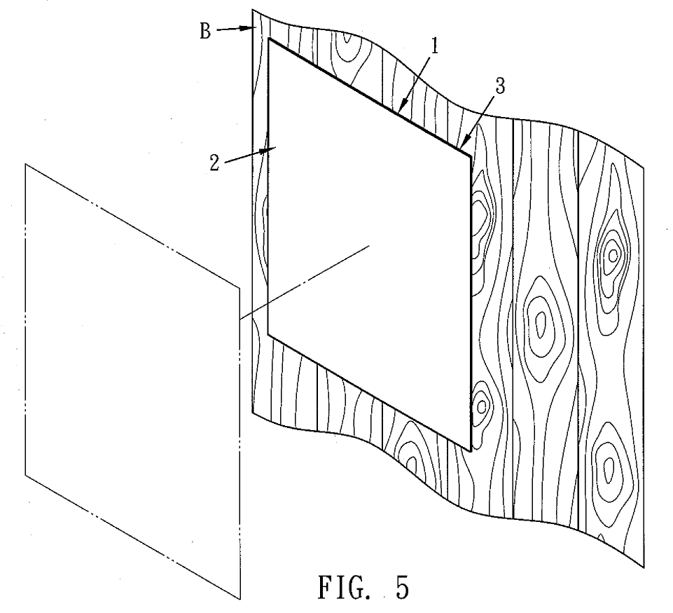

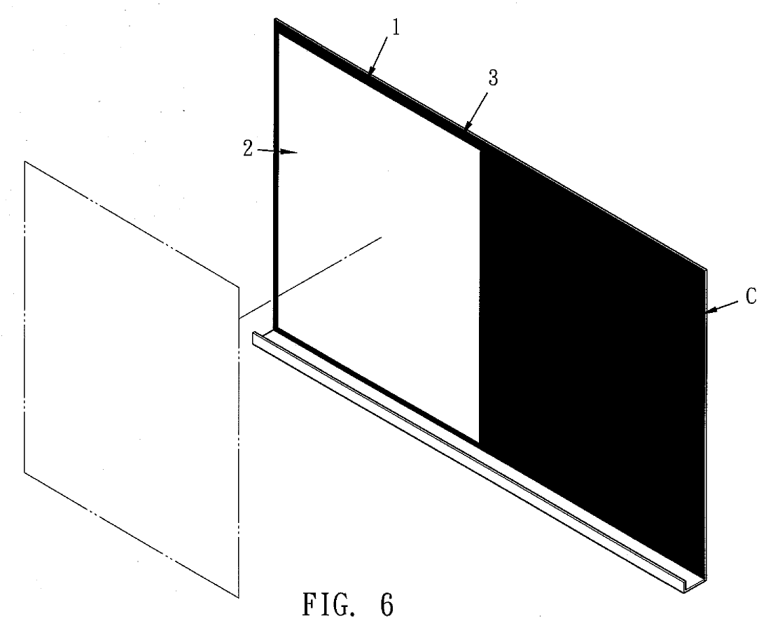

In use, as illustrated in FIGS. 4-6, the soft base material 1 can be cut to any desired size or type, and the adhesive layer 3 or the double sided tape is adhered to various objects, such as walls A, B, and a plate member C. Moreover, the soft base material 1 can be removed to roll as a cylinder, being portable easily.

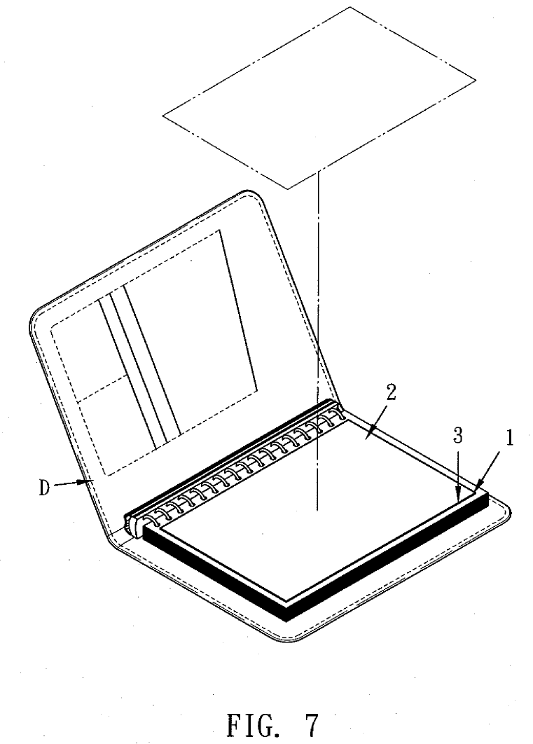

Referring to FIG. 7, the base material 1 is cut in a predetermined size smaller than that of a notebook D, and adhered onto the notebook D by ways of the adhesive layer 3 or the double sided tape so as to be written repeatedly. In addition, the base material 1 can be attached to a metal object by using a magnet.

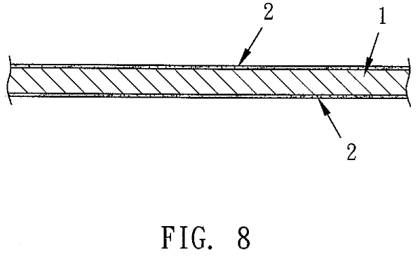

With reference to FIG. 8, a repeatedly written soft base material 1 in accordance with another embodiment of the present invention is a heat-proof aluminum foil paper that can be rolled as a cylinder. Both sides of the base material 1 are preprocessed and coated with a white writing layer 2 (can be coated with other colors as well) in a powder coating manner, thereby forming a double sided repeatedly written paper.

It is apparent form the above description that the present invention has the following advantages:

1. The base material can be portable, stored easily, and repeatedly adhered in various objects, such as a wall, a plate member, or a notebook.

2. The base material is made at lower cost.

3. The writing layer 2 is coated in a powder coating manner to prevent light reflection and to be written and rubbed easily and repeatedly.

4. The base material 1 can be cut to a desired size to be adhered onto various sizes of objects.

5. A user can write in the writing layer 2 by using a whiteboard pen, crayon, pencil, or chalk.

6. The soft base material 1 can be used repeatedly, obtaining environmental friendly purpose.

While we have shown and described various embodiments in accordance with the present invention, it is clear to those skilled in the art that further embodiments may be made without departing from the scope of the present invention.

What is claimed is:

1. A repeatedly written soft base material comprising a white writing layer coated on one side of the base material in a powder coating manner, the base material allowing to be cut in any desired size to be adhered onto various objects.

2. The repeatedly written soft base material as claimed in claim 1, wherein the base material is a heat-proof aluminum foil paper.

3. The repeatedly written soft base material as claimed in claim 1, wherein a repeatedly adhesive layer is disposed on another side of the base material.

4. The repeatedly written soft base material as claimed in claim 3, wherein on a surface of the adhesive layer of the base material is adhered a release paper.

5. The repeatedly written soft base material as claimed in claim 1, wherein on another side of the base material is mounted a double sided tape.

6. The repeatedly written soft base material as claimed in claim 1, wherein on both sides of the base material are fixed a writing layer.

7. The repeatedly written soft base material as claimed in claim 1, wherein the base material can be attached to a metal object by using a magnet.
